(19) United States
(12) Patent Application Publication
(10) Pub. No.: US 2023/0253552 A1
(43) Pub. Date: Aug. 10, 2023

(54) COATING FOR MAGNESIUM ELECTRODES

(71) Applicant: HONDA MOTOR CO., LTD., Tokyo (JP)

(72) Inventors: Anna RANDON-VITANOVA, Mainhausen (DE); Robert DOMINKO, Dol pri Ljubljani (SI); Nejc PAVLIN, Solkan (SI)

(21) Appl. No.: 18/156,397

(22) Filed: Jan. 19, 2023

(30) Foreign Application Priority Data
Jan. 27, 2022 (DE) 102022101871.7

(51) Int. Cl. H01M 4/36; H01M 4/38; H01M 4/62; H01M 4/134; H01M 4/1395; H01M 4/04

(52) U.S. Cl. CPC H01M 4/366; H01M 4/62; H01M 4/134; H01M 4/381; H01M 4/0402; H01M 4/1395; H01M 2004/027

(57) ABSTRACT

The present invention provides a magnesium anode and an electrochemical cell comprising the anode.

This application is based on and claims the benefit of priority from German Patent Application No.102022101871.7, filed on 27 Jan. 2022, the content of which is incorporated herein by reference.

### BACKGROUND OF THE INVENTION

### Field of the Invention

The present invention relates to an anode, comprising a main body which comprises or consists of an electrically conductive material, and a protective layer disposed on at least one surface of the main body, wherein the protective layer comprises or consists of silylated cellulose, optionally including at least one ion conductive additive, and solvent which solvates the at least one ion conductive additive which is present in the protective layer. The invention also relates to an electrochemical cell comprising the anode of the invention, and a method for coating a surface of an electrically conductive material.

### Related Art

Automobile exhaust gas regulations have been further advanced in order to reduce the adverse effects on the global environment. Thus, electric mobility in particular is playing an increasingly important role in avoiding automobile exhaust gas.

For many years, lithium-ion batteries have been the most commonly used rechargeable batteries in many modern life applications like laptops, cell phones and other portable devices. Also for electric cars and hybrid vehicles, lithium-ion batteries have provided an at the time considered acceptable cruising range and thus paved the way for the acceptance of electric mobility for the mass market.

WO 2020/007980 discloses preparation of trimethylsilyl cellulose coatings including ion conductive additive on the surface of a lithium metal anode.

Due to high costs of lithium as well as low availability, alternatives for lithium are urgently required and researchers aim at replacing the costly lithium by other materials which are less expensive, highly abundant and allow for preparation of rechargeable batteries with even higher capacities. Within the last decade, materials like especially aluminum, zinc and magnesium have shown promise as they provide better storage capacity in a charge per unit volume than lithium. All such materials are readily available in the large quantities that will be required as electric mobility advances further.

DE 10 2019 219 007 describes a process for producing a magnesium-based powder material for use in electrochemical cells, and negative electrodes and composite electrodes comprising such magnesium-based powder materials as well as electrochemical cells comprising such negative electrodes or composite electrodes.

### SUMMARY OF THE INVENTION

According to a first aspect, the invention provides an anode comprising a main body which comprises or consists of an electrically conductive material, and a protective layer disposed on at least one surface of the main body, wherein the protective layer comprises or consists of silylated cellulose, optionally including at least one ion conductive additive, and solvent which solvates the at least one ion conductive additive which is present in the protective layer.

A second aspect of the present invention relates to an electrochemical cell comprising the inventive anode as described herein, a cathode, a separator interposed between the anode and the cathode, and an electrolyte, wherein the protective layer is positioned on the electrolyte facing side of the anode.

A third aspect of the present invention relates to a method for coating a surface of an electrically conductive material, in particular a surface of an electrode with silylated cellulose or with silylated cellulose including at least one ion conductive additive, the method comprising (i) cleaning the surface of the electrically conductive material from any native passivation layer and impurities, (ii) optionally smoothening the cleaned surface, (iii) depositing a solution of silylated cellulose or a solution of silylated cellulose including at least one ion conductive additive on the surface, and (iv) evaporating the solvent, wherein the electrically conductive material comprises at least one of Mg, Zn, Ca, Al, K and Na.

In a fourth aspect, the present invention relates to the use of silylated cellulose optionally including at least one ion conductive additive as a protective layer on a surface of an electrically conductive material, in particular a surface of an anode, the at least one ion conductive additive which is present in the protective layer is solvated with solvent.

### BRIEF DESCRIPTION OF THE DRAWINGS

FIG. 1 illustrates a cross-section of a magnesium metal battery, in particular a magnesium secondary battery 1 of the present invention. The cell includes a negative current collector 2, a magnesium metal anode 3, an interfacial protective layer 4 (also termed herein “protective layer”), a separator membrane 5, a positive electrode 6 (cathode), and a positive current collector 7. FIG. 1 shows a preferred embodiment of the present invention.

The negative current collector 2 can be made of any electronically conductive material, for example, a metal foil such as a nickel foil, copper foil, stainless foil, preferably copper foil. It is important that the negative current collector is inert towards negative electrode 3.

Magnesium metal anode 3 attached to negative current collector 2 may be made from magnesium foil as described herein and includes interfacial protective layer 4 on the electrolyte facing side of the magnesium metal anode 3 opposite from negative current collector 2. Magnesium metal anode 3 should not be thicker than 1,000 µm, more preferably not more than 500 µm.

Element 5 represents a battery separator membrane soaked with liquid electrolyte medium. Such a separator 5 in the context of the present invention is a highly porous membrane, which prevents an electronic contact between positive and negative electrode, and may be made for example from polyolefins or glassy fibers. Such a separator 5 should not be thicker than 300 µm, preferably no thicker than 100 µm. Protective layer 4 comprises a solvent which solvates the at least one conductive additive which is present. Such solvents are described herein above. It is preferred that magnesium does not react with electrolyte medium used.

A positive electrode 6 is in contact with a separator membrane 5 opposite from negative magnesium anode 3. Positive electrode may be attached to the positive current collector 7 directly by using a slurry casting method or by pressing self-standing positive electrode on the current collector. The positive current collector 7 may be constituted of any electronically conductive material, preferably of carbon coated aluminium foil. Positive electrode 6 may comprise any magnesium intercalation compounds, sulphur or any polymeric organic compounds, either as a single phase material or mixed with a carbon or any other conducting compounds.

FIG. 2 represents a schematic illustration of repeated silylated anhydroglucose units in a cellulose molecule in accordance with the present invention. Cellulose is an organic compound consisting of a linear chain of β (1→4) linked D-glucose units. Cellulose base materials are well known to the person skilled in the art.

FIG. 3 shows stripping and deposition of symmetrical Mg-Mg-cells. Using TMSC-salt film the overpotential is lower and the cyclability longer.

FIG. 4: Polarisation increases and short circuit happens in the non-protected cell, while the cell with TMSC-salt film shows stable performance with much lower polarization. Using TMSC-Salt film, the overpotential is lower and the cyclability longer. The effect is more noticeable at higher number of cycles (longer time).

FIG. 5 shows SEM cross section images of brushed Mg compared to Mg with TMSC protective layer. TMSC provides a dense protective film on the Mg surface.

FIG. 6 shows SEM images of Mg with deposited TMSC protective layer. The TMSC-salt film adhesion on the Mg surface is very good. The surface of Mg is completely covered by the TMSC-salt film. The thickness of the layers is tuneable.

FIG. 7: The performance of protected Mg is also stable in not C1⁻-containing electrolyte.

FIGS. 8A,8B,8C: Stripping and deposition process showing reversibility of Mg deposition.

FIGS. 9A,9B,9C,9D: Electrodes having a protected surface of Mg powder and protected surface of Pt foils show a much longer cycle life.

### DETAILED DESCRIPTION OF THE INVENTION

The prior art discloses the preparation of trimethylsilyl cellulose including ion conductive additive coatings on the surface of a lithium metal anode. A lithium metal anode comprising such coating can work in an electrochemical cell without liquid electrolyte.

In the present invention the inventors observed that anodes including other metals, such as magnesium, can be produced with a trimethylsilyl cellulose coating including ion conductive additive. In considering the application of other metals, the inventors found that a solvent is needed to solvate the ionically conductive additives in the silylated cellulose. In particular, the solvent solvates crystals in the layer and ion conduction is done on those solvated crystals.

The anode surface, in particular the Mg anode surface, can be protected by silylated cellulose. The pores of the silylated cellulose can be filled with conductive salt, which is solid and seals the pores. The surface is ionically conductive and ensures the ion-transport, but does not let through any other species. This invention
prevents the passivation of the anode surface, in particular the Mg surface, thus enabling stable performance,
improves the deposition of the metal, in particular Mg, making it homogeneous, and/or
allows the usage of Cl-free electrolytes thus eliminating the corrosion issues in the electrochemical cell, in particular the Mg electrochemical cell.

In a first aspect, the invention provides an anode comprising a main body which comprises or consists of an electrically conductive material, and a protective layer disposed on at least one surface of the main body, wherein the protective layer comprises or consists of silylated cellulose, optionally including at least one ion conductive additive, and solvent which solvates the at least one ion conductive additive which is present in the protective layer.

According to a preferred embodiment, the electrically conductive material of the anode comprises at least one of Mg, Zn, Ca, Al, K, and Na. In a preferred embodiment, no lithium is included. Magnesium is particularly preferred.

“Magnesium” and “Mg” may be used interchangeably herein.

The present invention provides protection of the metal anode surface, in particular the Mg anode surface, by silylated cellulose or derivatives of cellulose. The pores of the silylated cellulose, i. e. the protective layer, can be filled with an ionically conductive additive such as a salt, which seals the pores. Embodiments comprising a conductive salt are preferred herein.

The solvent solvates the ion conductive additive which is added into the silylated cellulose. By this way, the surface is ionically conductive and ensures the ion transport, but does not lead through any other species.

The present invention provides anodes coated as described herein as well as electrochemical cells comprising such anodes. The coating as described herein prevents passivation of the anode surface, in particular Mg surface, which enables a stable performance. In particular, Mg anodes coated as described herein allow the usage of Cl-free electrolytes, thus eliminating corrosion issues in electrochemical cells and in particular Mg electrochemical cells.

The electrically conductive material of the anode main body may consists of a material selected from magnesium metal, magnesium metal alloy and any magnesium powder based materials also including magnesium alloy powders. Further metals which can be included in a magnesium alloy used within the present invention include Zn, Al, Si and/or Mn or any combinations thereof like Al—Zn or Al—Si. Preferably, Mg metal alloys or alloy powders according to the invention do not comprise Li. The person skilled in the art understands that “do not comprise” in this context does not exclude inevitable Li impurities.

For example, the anode main body can be a magnesium foil having a thickness of not more than 1,000 µm, preferably not more than 500 µm.

According to an especially preferred embodiment of the inventive anode, the main body consists of the electrically conductive material Mg, wherein the protective layer consists of silylated cellulose.

The at least one conductive additive may be in particular a salt of the electrically conductive material(s).

The at least one ion conductive additive may be present in the protective layer in a mass ratio being ion conductive additive and silylated cellulose of 1 to 10, preferably 3 to 8 and most preferably 5.

The at least one conductive additive including one or more salts of the electrically conductive material(s) as defined herein, may comprise an anion selected from the group borohydride, bis(trifluoromethane) sulfonimide, bis(fluorosulfonyl)imide, chloride, (BH₄) (NH₂), hexafluoroisopropyl borate, 2-trifluoromethyl-4,5-dicyanoimidazole, a closo-dodecaborate family anion, pentacyanoborate, bis(hexamethyldisilazide), perchlorate, bromide, iodide, B (ORₓ) ₄, and hexafluorophosphate.

The at least one conductive additive may in particular be a magnesium salt, preferably a magnesium salt selected from the group consisting of Mg(BH₄)₂ (magnesium borohydride), Mg(TFSI)₂ (magnesium bis(trifluoromethane) sulfonimide), Mg(FSI)₂ (magnesium bis(fluorosulfonyl)imide), MgCl₂ (magnesium chloride), Mg (BH₄) (NH₂), Mg [B (hfip) ₄] ₂ (magnesium hexafluoroisopropylborate), Mg(TDI)₂ (magnesium 2-trifluoromethyl-4,5-dicyanoimidazole), Mg[R—B₁₂H₁₁] (magnesium closo-dodecaborate family), MgB(CN)₅ (magnesium pentacyanoborate), Mg(HMDS)₂ (magnesium bis(hexamethyldisilazide)), Mg(ClO₄)₂ (magnesium perchlorate), MgBr₂ (magnesium bromide), MgI₂ (magnesium iodide), Mg(B(ORₓ)₄)₂, Mg(PF₆)₂ (magnesium hexafluorophosphate), or any combination thereof, most preferably Mg(BH₄)₂, or a corresponding salt of calcium or zinc.

It is especially preferred that the at least one conductive salt is a Na or K salt, preferably one or more of the respective nitrate, tetrafluoroborate, perchlorate, hexafluorophosphate, thiocyanate hydrate, trifluoromethane sulfonate, bis(trifluoromethane) sulfonimide, bis(fluorosulfonyl) imide, tetracyanoborate, bis(oxalate) borate, 4,5-dicyano-1,2,3,triazolate or 2-trifluoromethyl-4,5-dicyanoimidazole.

According to another preferred embodiment, the at least one ion conductive additive is an aluminium salt, which may be preferably one or more of AlCl₃, Al(TFSI)₃, Al(PF₆)₃, Al(FSI)₃, Al (ClO₄) ₃, AlBr₃ and any combination thereof.

According to another preferred embodiment a Mg anode as described herein is used in combination with at least one Li conductive salt. Preferred Li conductive salt are selected from group Li(BH₄), LiNO₃, LiBF₄, LiClO₄, LiPF₆, LiTf, LiSCN, LiTFSI, LiFSI, LiB(CN)₄, LiBOB, LiDCTA, LiTDI and any combination thereof.

Any of the conductive salts described herein may be combined provided that the resulting mixture is chemically stable and/or inert.

The protective layer may have preferably a thickness in the range of 100 nm to 500 pm, preferably 10 µm to 50 µm, and even more preferable 1 µm to 10 µm.

For good functionality, the protective layer preferably possesses high ionic conductivity, but at the same time, it is impermeable for other battery components.

Silylated cellulose (also named silyl cellulose) for use in a protective layer of the present invention can in principle be any reaction product of cellulose with a silylating agent. In silylated cellulose, one or more hydroxy groups of the glucose units forming cellulose are substituted with a silyl group. In principle, up to three hydroxy groups can be substituted. According to the present invention, the silylated cellulose preferably comprises 0.5 to 3 silyl groups per glucose unit in the cellulose. More preferred are 2 to 3 silyl groups per glucose unit. The silyl groups can be the same or different —SIR₃ groups, wherein each R can be the same or different. Preferred residues R are independently selected from the group consisting of alkyl, cycloalkyl, alkenyl, alkoxy, aryl, and alkylaryl. The alkyl group may have 1 to 12 carbon atoms (C₁₋₁₂ alkyl), in particular 1 to 4 carbon atoms (C₁₋₄ alkyl). The cycloalkyl group may have 3 to 12 carbon atoms (C₃₋₁₂ cycloalkyl). The alkenyl group may have 2 to 12 carbon atoms (C₂₋₁₂ alkenyl). The alkoxy group may have 1 to 12 carbon atoms (C₁₋₁₂ alkoxy), in particular 1 to 4 carbon atoms (C₁₋₄ alkyl). The aryl group may have of 6 to 12 carbon atoms (C₆₋₁₂ aryl). The alkylaryl group may have 7 to 13 carbon atoms (C₇₋₁₃ alkylaryl). Especially preferred are alkyl residues, in particular C₁₋₄ alkyl. According to an especially preferred embodiment alkyl is methyl.

The silylated cellulose can be derived from microfibrillated or nanofibrillated cellulose, microcrystalline or nanocrystalline celluloses or bacterial celluloses. Preferred are nanofibrillated celluloses.

According to an especially preferred embodiment silylated cellulose, in particular a silylated cellulose based film, is prepared using silylated nano fibrillated cellulose (“TMSC” -TriMethylSilyl Cellulose) and magnesium borohydride in an organic solvent like tetrahydrofuran, dimethyl sulfoxide, propylene carbonate, Trichloromethane, glymes or other solvents compatible with Mg. Tetrahydrofuran is in particular preferred. For such TMSC-salt films as protective layer on a conductive material, in particular Mg, a dry thickness of 20 µm to 40 µm, in particular about 30 µm is preferred.

In a preferred embodiment, the solvent, which solvates the at least one ion conductive additive which is present in the protective layer, is selected from polar aprotic solvents. Such preferred solvents may be tetraglyme (2,5,8,11,14-pentaoxapentadecane), glyme (1,2-dimethoxyethane), diglyme (1-methoxy-2-(2-methoxyethoxy)ethane), triglyme (1,2-bis(2-methoxyethoxy)ethane), THF (tetrahydrofuran), PC (propylene carbonate), EC (ethylene carbonate), ACN (acetonitrile), DMSO (dimethyl sulfoxide), sulfolane (tetrahydrothiophene-1,1-dioxide), DMF (dimethyl formamide) NMP (N-methyl pyrrolidinone), and most preferably includes or is tetraglyme. Of course, any suitable mixtures of such solvents are also within the present invention.

The polar aprotic solvent may be also included in the electrolyte in an amount of 10 to 100 vol.-%, more preferably 30 to 70 vol.-%, in a most preferred embodiment in an amount of about 50 vol.-%.

A second aspect of the present invention relates to a electrochemical cell comprising the inventive anode as described herein, a cathode, a separator interposed between the anode and the cathode and an electrolyte, wherein the protective layer is positioned on the electrolyte facing side of the anode.

The electrochemical cell according to the invention may comprise a negative current collector on the opposite side of the anode facing away from the electrolyte and/or a positive current collector on the side of the cathode facing away from the electrolyte. Such current collectors are preferably made of an electrically conductive material inert to the material of the anode and cathode, respectively. According to a preferred aspect of the invention, the inventive electrochemical cell is a cell magnesium battery, in particular a magnesium secondary battery.

The negative current collector may for example comprise a metal foil, a metal mesh or metal strip, wherein the metal may be, for example, nickel, copper or stainless steel. The positive current collector may for example, comprise a carbon coded aluminium foil or mesh.

As the cathode in principle any common materials can be used. For example, the cathode may comprise a magnesium or any other metal insertion compound, sulphur and/or a redox active organic compound, either as a single phase material or as a mixed material, such as mixed with carbon or other electrically conducting compounds and with binder. According to a preferred embodiment also the cathode may be protected with a protective layer as herein described.

The electrochemical cell of the invention may have a cathode, a separator soaked with an electrolyte and a magnesium metal anode with protective layer placed between magnesium metal anode and the separator soaked with electrolyte.

The separator may in principle be made of any common material suitable to separate the anode compartment and the cathode compartment. For example, the separator may comprise a porous membrane soaked with electrolyte.

Any suitable electrolyte can be used. As the electrolyte, for example, a polar solvent with a salt like a magnesium salt dissolved therein can be used. However, any other electrolyte materials are suitable as well. Preferably the electrolyte is Cl-free, thus eliminating corrosion issues in electrochemical cells, in particular Mg-cells. Also in such electrochemical cells which do not contain Cl comprising electrolytes the performance of Mg anodes protected as herein described is stable.

Of course, it is preferred that magnesium does not react with electrolyte medium used.

A third aspect of the invention is a method for coating a surface of an electrically conductive material. The method for coating a surface of an electrically conductive material with silylated cellulose or else with silylated cellulose including at least one ion conductive additive is for example described in WO 2020/007980, which is included herein by reference.

In particular, the inventive method for coating a surface of an electrically conductive material, e.g. Mg, in particular a surface of an electrode with silylated cellulose or with silylated cellulose including at least one ion conductive additive, may comprise
(i) cleaning the surface of an electrically conductive material from any negative passivation layer and impurities,
(ii) optionally smoothening the cleaned surface,
(iii) depositing a solution of silylated cellulose or else, a solution of silylated cellulose including at least one ion conductive additive on the surface, and
(iv) evaporating the solvent.

Such method provides an easy straight forward preparation and simple coating technique. The method may provide protection for metal Mg, Mg-alloys and/or Mg powder-based electrodes.

The adhesion of the coated silyl-cellulose based film on the electrically conductive material, such as TMSC-film on a Mg-surface, is very good. The thickness of the film layer is tunable. Preferably, the surface of the electrically conductive material is essentially completely covered.

Before forming a protective layer, the surface to be coated, in particular the magnesium surface, is desirably activated. For that purpose, the surface is cleaned in step (i) from any passivation layer and impurities. Activation increases reactivity of the surface, and in this way, enhances adhesion between the magnesium material and the silylated cellulose, or else, the silylated cellulose including at least one ion conductive additive protective layer. Activation could be executed with extrusion from ingot or with mechanical scratching of the surface.

The cleaning step can be followed by an optional smoothening of the surface in step (ii), for example by rolling with a roller to align the surface. The surface should be activated and cleaned of native passive layer and impurities, and finally smoothened, so that the protective layer is well attached.

In subsequent step (iii), a solution of silylated cellulose or else, a solution of silylated cellulose including at least one ion conductive additive is deposited on the cleaned and optionally smoothened surface. Therefore, silylated cellulose or else, silylated cellulose and at least one ion conductive additive is dissolved in an appropriate solvent, and the surface is contacted with this solution. Deposition of silylated cellulose or else, silylated cellulose including at least one ion conductive additive solution could be achieved with different techniques including solution coating, solution casting, spray coating, spin coating, dip coating, electro-spinning, or by using Langmuir-Blodgett coating technique. The selection of the deposition technique is in the greatest extent governed by desirable thickness of the protective layer, and with the size of the surface area desired to be coated. Regarding thickness, protective layer should be as thin as possible while still effectively protecting the metal electrode, in particular the magnesium metal electrode. Thickness of the layer will influence the flexibility and ionic conductivity of the interfacial protective layer. A high quality protective layer should be smooth and continuous and free of pores or defects that could provide a pathway for deleterious agents from the electrolyte.

Finally, in step (iv), the solvent is evaporated. Corresponding techniques are known to the person skilled in the art.

In the method of the invention the electrically conductive material may be as described above and/or may comprise at least one of Mg, Zn, Ca, Al, K and Na. Preferred is Mg.

In the method of the invention, the electrically conductive material can selected from magnesium metal, a magnesium metal alloy and magnesium powder based material as described above.

The at least one ion conductive additive is preferably a magnesium salt, in particular a magnesium salt selected from the group consisting of Mg(BH₄)₂ (magnesium borohydride), Mg(TFSI)₂ (magnesium bis(trifluoromethane) sulfonimide), Mg(FSI)₂ (magnesium bis(fluorosulfonyl)imide), MgCl₂ (magnesium chloride), Mg (BH₄) (NH₂), Mg [B (hfip) ₄] ₂ (magnesium hexafluoroisopropylborate), Mg(TDI)₂ (magnesium 2-trifluoromethyl-4,5-dicyanoimidazole), Mg[R—B₁₂H₁₁] (magnesium closo-dodecaborate family), MgB(CN)₅ (magnesium pentacyanoborate), Mg(HMDS)₂ (magnesium bis(hexamethyldisilazide)), Mg(ClO₄)₂ (magnesium perchlorate), MgBr₂ (magnesium bromide), MgI₂ (magnesium iodide), Mg(B(ORₓ)₄)₂, Mg(PF₆)₂ (magnesium hexafluorophosphate), or the combination between them, most preferably Mg(BH₄)₂. A fourth aspect of the invention is the use of silylated cellulose optionally including at least one ion conductive additive as a protective layer on a surface of an electrically conductive material, in particular a surface of an anode, the at least one ion conductive additive which is present in the protective layer is solvated with solvent.

In particular, this aspect of the present invention can be used to coat any commercially available electrically conductive material and in particular the surface of anodes commonly used in the technical field. In a particularly preferred embodiment, anode material for batteries, is coated. The Examples and FIGS. 8A-8C and 9A-9D clearly show that protective coating of magnesium electrodes with silylated cellulose can provide beneficial effects and, in particular, an extended cycle life.

In the use as described herein, the electrically conductive material may be selected from magnesium metal, a magnesium metal alloy and magnesium powder based material as described above, and/or wherein the at least one ion conductive additive is a magnesium salt, preferably a magnesium salt selected from the group consisting of Mg(BH₄)₂ (magnesium borohydride), Mg(TFSI)₂ (magnesium bis(trifluoromethane) sulfonimide), Mg(FSI)₂ (magnesium bis(fluorosulfonyl)imide), MgCl₂ (magnesium chloride), Mg (BH₄) (NH₂), Mg [B (hfip) ₄]₂ (magnesium hexafluoroisopropylborate), Mg(TDI)₂ (magnesium 2-trifluoromethyl-4,5-dicyanoimidazole), Mg[R—B₁₂H₁₁] (magnesium closo-dodecaborate family), MgB(CN)₅ (magnesium pentacyanoborate), Mg(HMDS)₂ (magnesium bis(hexamethyldisilazide)), Mg(ClO₄)₂ (magnesium perchlorate), MgBr₂ (magnesium bromide), MgI₂ (magnesium iodide), Mg(B (OR_{X}) ₄)₂, Mg(PF₆)₂ (magnesium hexafluorophosphate), or the combination between them, most preferably Mg(BH₄)₂.

According to the present invention, the electrically conductive material being selected from magnesium metal, a magnesium metal alloy and in particular magnesium powder based material and the at least one ion conductive additive being Mg(BH₄)₂ is in particular preferred.

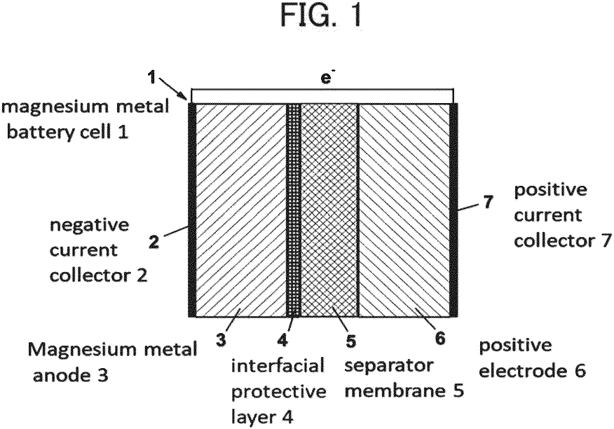

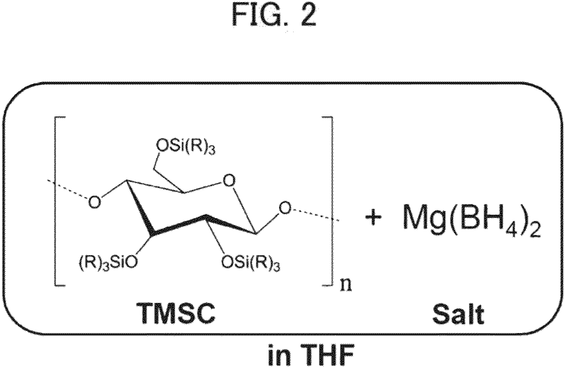

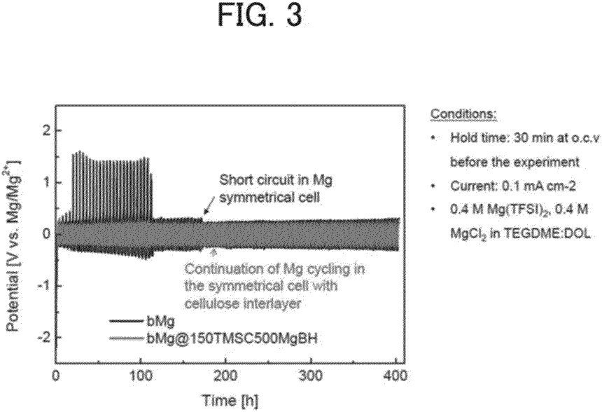

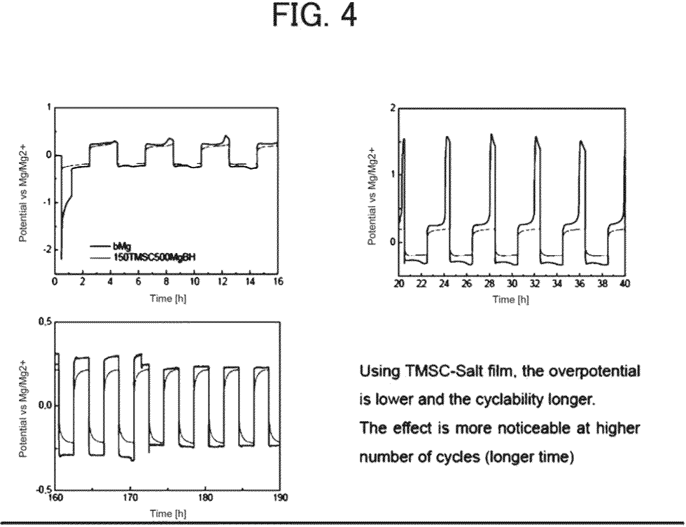

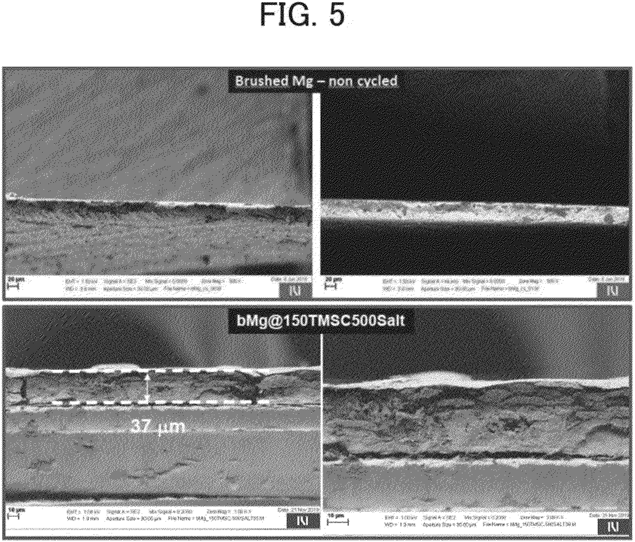

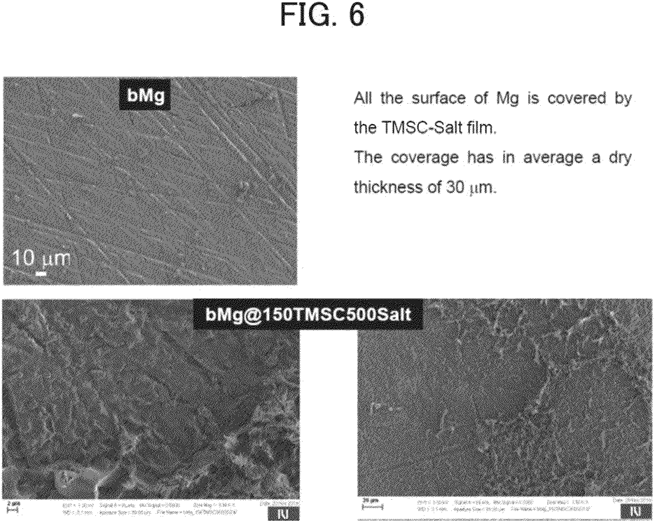

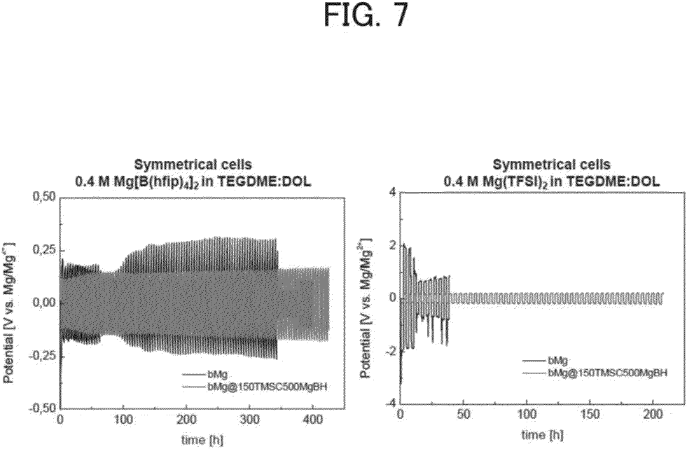

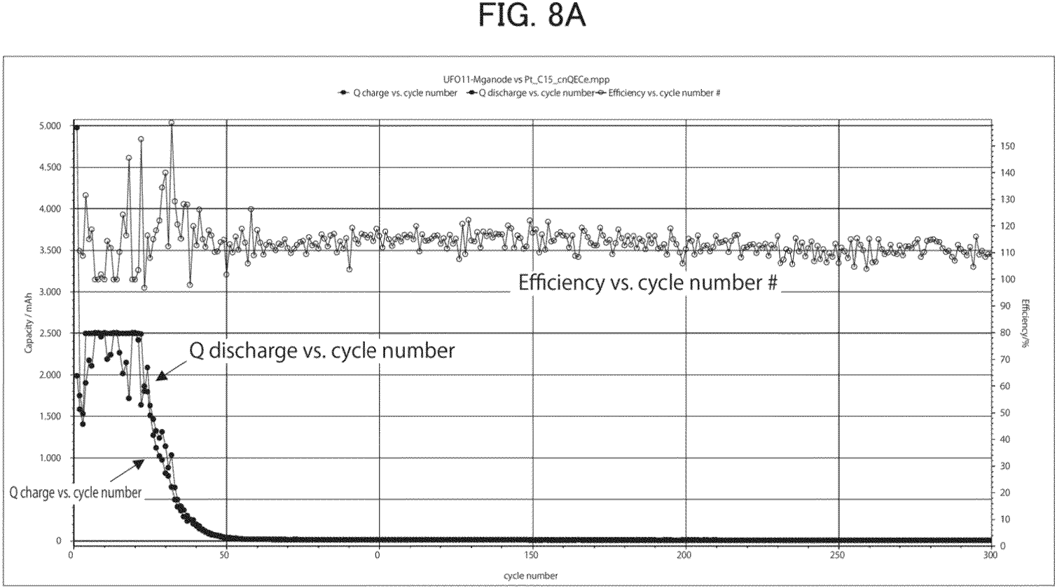

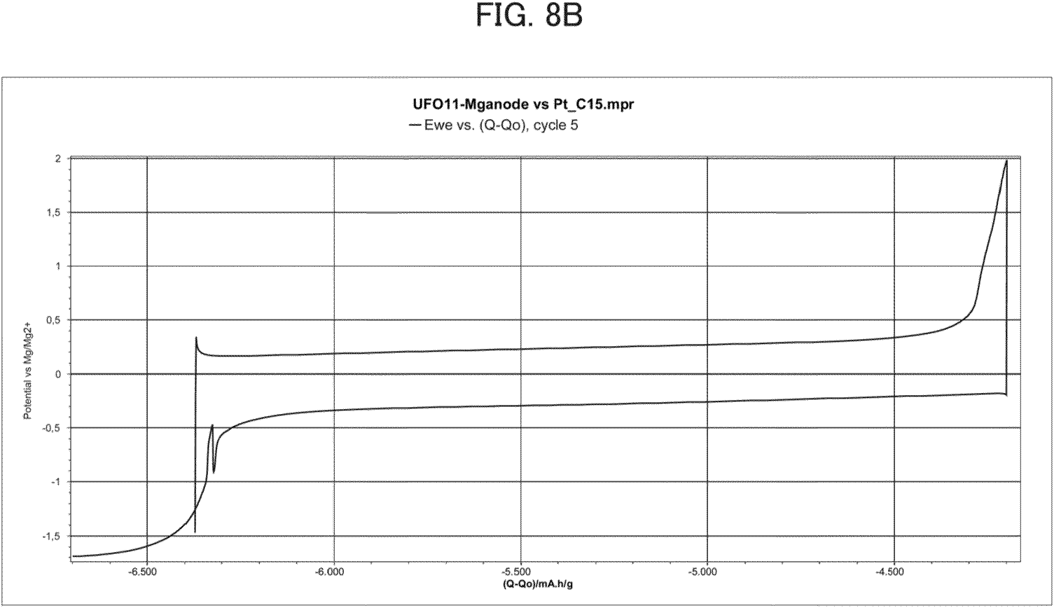

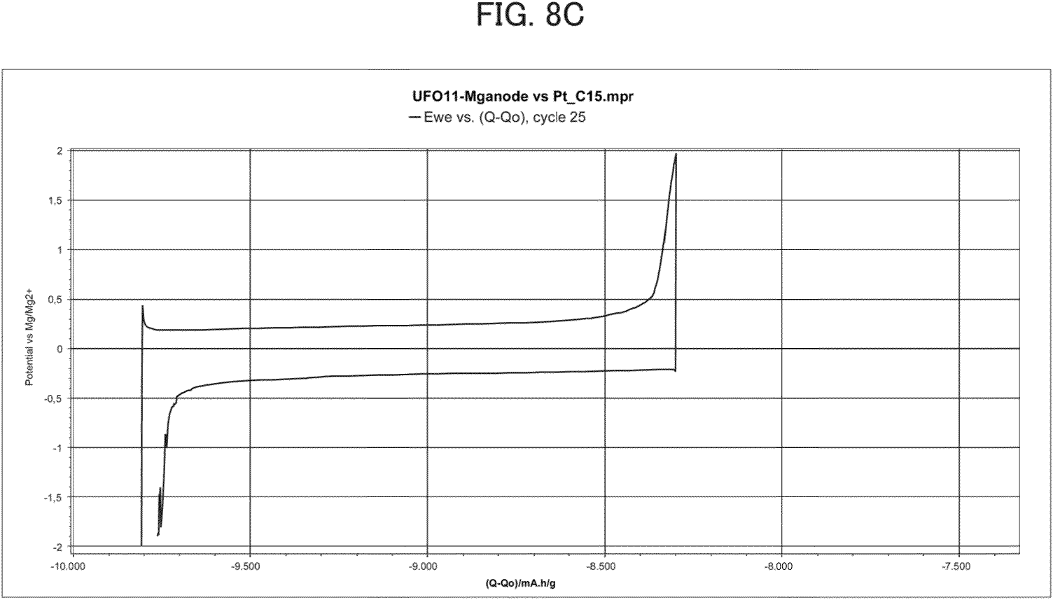

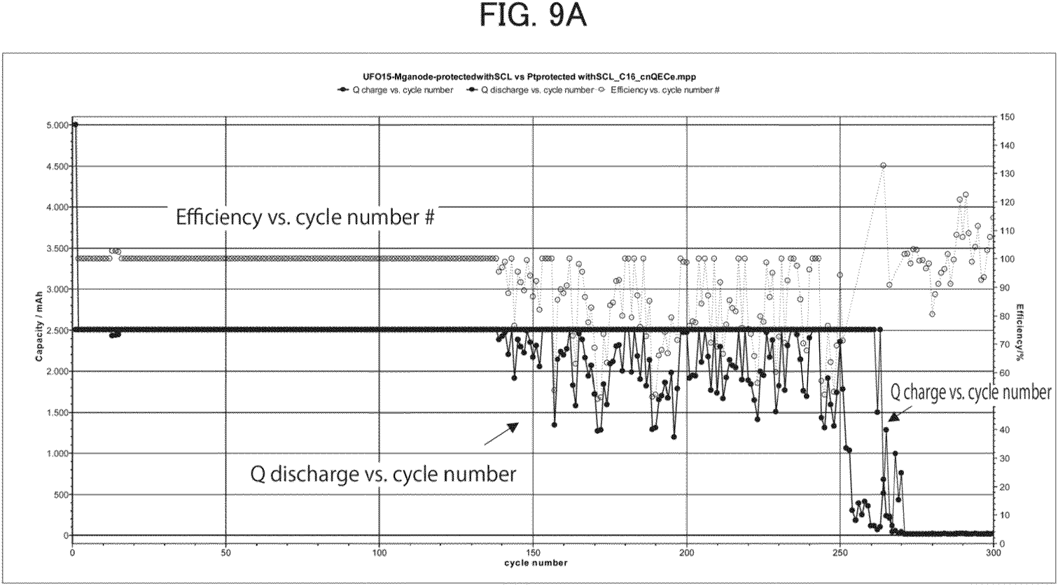

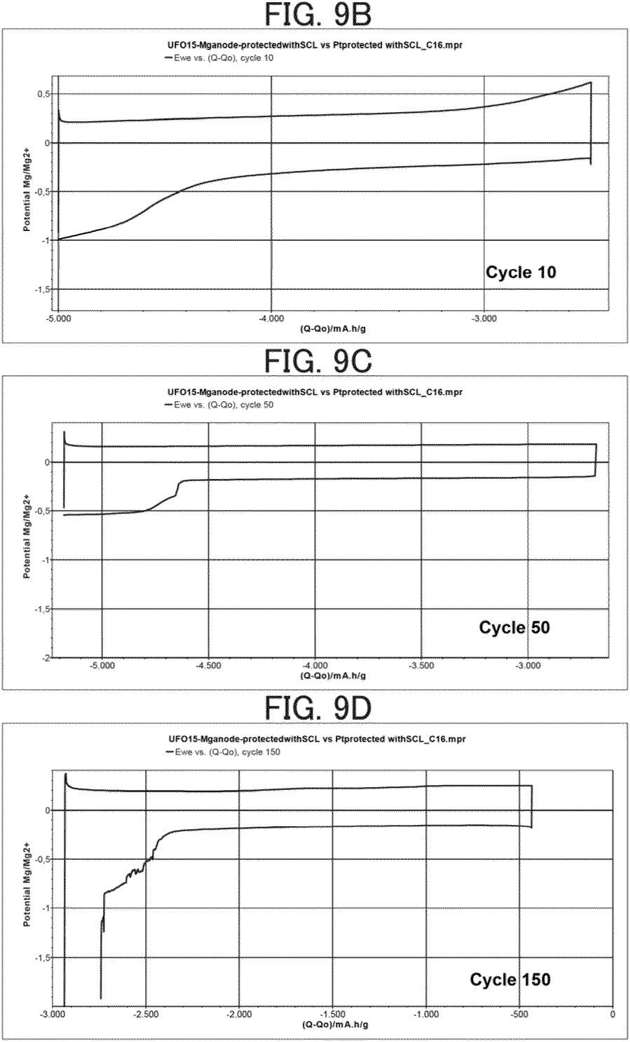

The invention is further illustrated by FIGS. 1 to 9, and the Examples.

### EXAMPLES

### Stripping/Deposition Showing Reversibility of Mg Deposition

The experiment was designed using UFO type cells as follows: an excess of Mg was deposited on the Pt foil (5000 mAh) and half of this amount (2500 mAh) was stripped away. After that continuously 2500 mAh of the capacity of magnesium was deposited and stripped.

Stripping and deposition of Mg on the Pt foil is not fully reversible although an excess of Mg was added in the first cycle. This is due to passivation of Mg when fresh magnesium surface is exposed to the electrolyte.

Two experiments were carried out:
1) bare surface of Mg powder and bare surface of Pt foil
2) protected surface of Mg powder and protected surface of Pt foil
3) Protection was done with silylated cellulose and Mg(BH₄)₂ as a salt incorporated between cellulose fibers.

The experiment shows the quality of the protection layer i.e. how many cycles are needed to lose one fold excess of magnesium. If the degradation is severe, the experiment fails after few cycles (there is not enough magnesium and 2500 mAh cannot be obtained).

This observed in the case of bare surface (cf. FIGS. 8A-8C). After approx. 25 cycles pre-deposited magnesium is run-out and with each cycle more magnesium is lost than deposited. For this reason capacity after 100 cycles is zero.

FIGS. 9A-9D shows the same experiment with protection layer. Cycle life is much longer. Degradation is due to the so-called edge effect* - edges were not protected, but overall protection layer enables approximately 10 times longer life time of the cell. This shows without any doubt the technological impact of the present invention.

*Edge effect means, that the edges of the electrodes are not very well covered by the protective layer. This is usual in non optimized lab cells. This effect may be eliminated when the cell engineering is optimized.

What is claimed is:

1. Anode, comprising
a main body which comprises or consists of an electrically conductive material,
and a protective layer disposed on at least one surface of the main body,
wherein the protective layer comprises silylated cellulose,
including at least one ion conductive additive, and solvent which solvates the at least one ion conductive additive which is present in the protective layer.

2. The anode of claim 1,
wherein the electrically conductive material of the anode comprises at least one of Mg, Zn, Ca, Al, K and Na.

3. The anode of claim 1,
wherein the electrically conductive material of the anode main body consists of a material selected from magnesium metal, magnesium metal alloy and magnesium powder-based materials, and wherein the anode main body is a magnesium foil having a thickness of not more than 1000 µm.

4. The anode of claim 1,
wherein the at least one ion conductive additive is a salt of the electrically conductive material(s).

5. The anode of claim 1,
wherein the at least one ion conductive additive is present in the protective layer in a mass ratio between ion conductive additive and silylated cellulose of 1 to 10.

6. The anode of claim 1,
wherein the at least one ion conductive additive includes one or more salts of the electrically conductive material(s) comprising an anion selected from the group comprising
borohydride, bis(trifluoromethane) sulfonimide, bis(fluorosulfonyl)imide, chloride, (BH₄) (NH₂), hexafluoroisopropyl borate, 2-trifluoromethyl-4,5-dicyanoimidazole, a closo-dodecaborate family anion, pentacyanoborate, bis(hexamethyldisilazide), perchlorate, bromide, iodide, B(ORₓ)₄, and hexafluorophosphate.

7. The anode of claim 1,
wherein the at least one ion conductive additive is a magnesium salt.

8. The anode of claim 1,
wherein the at least one ion conductive additive is a Na or K salt.

9. The anode of claim 1,
wherein the at least one ion conductive additive is an aluminum salt.

10. The anode of claim 1,
wherein the protective layer has a thickness in a range of 100 nm to 500 µm.

11. The anode of claim 1,
wherein silylated cellulose comprises 0.5 to 3 silyl groups per glucose unit in the cellulose.

12. The anode of claim 11,
wherein the silyl groups are the same or different groups -SiR₃, wherein each R is independently selected from the group consisting of alkyl, cycloalkyl, alkenyl, alkoxy, aryl, and alkylaryl.

13. The anode of claim 1,
wherein the silylated cellulose is derived from microfibrillated or nanofibrillated celluloses, microcrystalline or nanocrystalline celluloses or bacterial celluloses.

14. Electrochemical cell,
comprising an anode, a cathode, a separator interposed between the anode and the cathode and an electrolyte, wherein the anode is as defined in claim 1, wherein the protective layer is positioned on the electrolyte facing side of the anode.

15. Electrochemical cell according to claim 14,
wherein the solvent is selected from polar aprotic solvents.

16. Electrochemical cell according to claim 15,
wherein the polar aprotic solvent is included in the electrolyte in an amount of 10 to 100 vol.-%.

17. The electrochemical cell of claim 14,
further comprising a negative current collector on the opposite side of the anode facing away from the electrolyte and/or a positive current collector on the side of the cathode facing away from the electrolyte, wherein the current collectors are made of an electrically conductive material inert to the material of the anode and cathode, respectively.

18. The electrochemical cell of claim 14,
which is a magnesium secondary battery.

19. Method for coating a surface of an electrically conductive material, with silylated cellulose or with silylated cellulose including at least one ion conductive additive, the method comprising
(i) cleaning the surface of the electrically conductive material from any native passivation layer and impurities,
(iii) depositing a solution of silylated cellulose or a solution of silylated cellulose including at least one ion conductive additive on the surface, and
(iV) evaporating the solvent,
wherein the electrically conductive material comprises at least one of Mg, Zn, Ca, Al, K and Na.

20. The method of claim 19,
wherein the electrically conductive material is selected from magnesium metal, a magnesium metal alloy and magnesium powder based material, and/or wherein the at least one ion conductive additive is a magnesium salt.

21. The method of claim 20,
wherein depositing a solution of silylated cellulose or a solution of silylated cellulose including at least one ion conductive additive on the surface comprises solution coating, spray coating, spin coating, dip coating, electro-spinning, or Langmuir-Blodgett coating.

22. Use of silylated cellulose including at least one ion conductive additive as a protective layer on a surface of an electrically conductive material, the at least one ion conductive additive which is present in the protective layer is solvated with solvent.

23. The use of claim 22,
wherein the electrically conductive material is selected from magnesium metal, a magnesium metal alloy and magnesium powder based material, and/or wherein the at least one ion conductive additive is a magnesium salt.
